(19) United States
(12) Patent Application Publication
(10) Pub. No.: US 2009/0113412 A1
(43) Pub. Date: Apr. 30, 2009

(54) METHOD AND APPARATUS FOR ENHANCED SYNCHRONIZATION PROTOCOL

(75) Inventors: Aidan SHRIBMAN, Tel Aviv (IL); Alexander DROBINSKY, Raanana (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP PORTALS ISRAEL LTD., Raanana (IL)

(21) Appl. No.: 11/926,170

(22) Filed: Oct. 29, 2007

(51) Int. Cl. G06F 9/44

(52) U.S. Cl. 717/170

(57) ABSTRACT

A method and apparatus for synchronizing a file between a sender and a receiver. The sender comprises a base version of the file and optionally one or more delta files. The receiver issues a request to get updates for the file and indicates a unique ID associated with the version available at the receiver. The sender determines the version available to the receiver, and updates the receiver with all delta files accumulated since the receiver received the last update of the file. If the version of the receiver is older than the base version, then the base version and all delta files are sent to the receiver.

### TECHNICAL FIELD

The present invention relates to the field of data transfer in general, and to an apparatus and method for synchronized file transfers in distributed file systems in particular.

### BACKGROUND

As software products, or other products involving software are getting larger and more complex, and as globalization trends are becoming more popular, it is more common that multiple geographically dispersed groups of people work together on the same project and have to share digital data stored on one central repository. In addition, as the amount and volume of shared files grow rapidly, the burden on the communication channels, the bandwidth and efficiency requirements increase.

Often, the shared files include complex file or folder hierarchies comprising a large number of files. The file hierarchy is stored on one or more sender repositories, from which it is distributed to multiple receiver repositories. Each receiver repository may store an updated or an outdated version of the file hierarchy, wherein an outdated version may comprise previous and different versions of one or more files from the hierarchy. Thus, it is reasonable to avoid transferring the whole hierarchy when possible, and to transfer only the data necessary for constricting the updated hierarchy.

A known system for distributing file hierarchies is the RSYNC application (http://rsync.samba.org) used in UNIX operating systems. RSYNC uses delta-transferring of files for more efficient bandwidth utilization, but RSYNC suffers from a number of limitations. First, since the RSYNCH algorithm requires many computations for each transfer of file from a sender to a receiver, the number of receivers that can address each sender is limited. In addition, RSYNC is not very efficient with regards to bandwidth utilization: as RSYNC does not have access to the content of the actual file residing on the receiver but only to a checksum thereof, calculating the file differences yields a sub-optimal result.

Another known solution is a source control system such as SUBVERSION (http://www.subversion.com). However, a source control system requires a significant amount of space to be allocated for the repository as source control systems store all history and do not evict outdated data. In addition, the receiver typically has to maintain local meta-data, such as version of each file, source control repository server address, or the like, thus coupling between the receiver and the sender repository. Such coupling does not allow using load-balancing techniques by having multiple senders work simultaneously. Yet another drawback of a source control system is that due to the big variance in requests, such system can implement only limited caching techniques.

There is thus a need for a method and system for enabling distribution of file structures from one or more senders to one or more receivers. The system and apparatus should enable efficient storage on the sender side, efficient processing on both the sender and on the receiver side, and relatively low bandwidth consumption from the distribution channel.

### SUMMARY

The disclosure relates to synchronizing one or more receiver computing platforms with file versions available at one or more sender computing platforms in an efficient manner, by saving storage space and bandwidth utilization. At each sender, a base version is stored for each file, and optionally one or more delta files. Each version and each delta file are identified by a unique ID. A receiver preferably indicates the ID of a file it has, and the server sends only the relevant and required updates. According to predetermined rule, a new base version is stored comprising all the accumulated changes.

A first aspect of the disclosure discloses in a computerized network comprising a sender computing platform and a receiver computing platform, a method for synchronizing one or more files between the sender computing platform and the receiver computing platform, the method comprising: storing a base version for each file at the sender; storing a collection comprising one or more delta files associated with each file at the sender; determining a version of each file available at the receiver; sending a full version of each file or a delta file; and updating the base version at the receiver computing platform, or applying the delta file to a previous version at the receiver computing platform. The method optionally comprises the step of sending a request from the receiver computing platform to the sender computing platform, the request indicating the file to be synchronized and an identifier associated with the file. The method can further comprise a step of determining a unique ID for the base version of the file. The method can further comprise a step of determining a unique ID for a version of the file, the version of the file comprising the base version of the file, at which the delta file is applied. Within the method, the delta file sent to the receiver optionally comprises all delta files that have been stored at the sender computing platform after all earlier delta files were sent to the receiver computing platform. Within the method, the full version is optionally the base version, or the full version is generated by applying the delta files on the base version. Within the method, the full version is optionally cached by the sender. The method optionally comprises the step of issuing one or more notifications from the sender computing platform to the receiver computing platform related to one or more updated files. The method can further comprise the step of determining one or more identifiers associated with a version of the file stored at the receiver computing platform. The method can further comprise the steps of: evicting the base version and the delta files; and storing an updated base version of the file.

A second aspect of the disclosure relates to an apparatus for synchronizing one or more files between a sender computing platform and a receiver computing platform, the sender computing platform comprising: a storage unit for storing a base version for each file and one or more delta files for each file; a synchronization manager for determining whether any file needs to be updated; a repository revision manager for managing the base version and the delta files; a cache aging determination component for determining whether to evict the base version and the delta files; a file unique ID determination component for determining a unique ID of the base version or a unique ID of the base version at which a delta file was applied; a communication component for sending files to the receiver; the receiver computing platform comprising: a storage unit for storing the base version for each file or a delta file for each file; a synchronization manager for issuing an update request to the sender related to any file; a delta application component for applying one or more delta files to a stored version of any file; and a communication component for receiving files from the receiver. Within the apparatus the receiver optionally further comprises a synchronization manager for issuing an update request to the sender related to any file. The receiver can further comprise a file unique ID determination component for determining a unique ID of a base version, or a unique ID of a base version at which a delta file is applied. Within the apparatus, the sender can further comprise a delta determination component for determining a delta file between two versions of a file.

### BRIEF DESCRIPTION OF THE DRAWINGS

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

FIG. 1 is a schematic illustration of a typical environment in which the disclosed method and apparatus are used;

FIG. 2 is a schematic illustration showing how a file X is stored in the sender repository, in accordance with preferred embodiments of the disclosed subject matter;

FIG. 2 is a schematic block diagram of the basic elements of a receiver, in accordance with preferred embodiments of the disclosed subject matter;

FIG. 3 is a schematic block diagram of the basic elements of a sender, in accordance with preferred embodiments of the disclosed subject matter; and

FIG. 5 is a flowchart of the main steps in distributing files from a sender to a receiver, in accordance with preferred embodiments of the disclosed subject matter.

### DETAILED DESCRIPTION

In exemplary embodiments of the disclosed subject matter, one or more senders are connected via a communication channel to one or more receivers, wherein the senders comprise up-to-date versions of one or more files or folders which are to be sent to the receivers, either upon request of a receiver, at the sender's initiative or according to a predetermined rule, such as a period of time elapsed since the last update. In a preferred embodiment, a receiver stores for each file a base version of the file, which contains the whole file as it has been at some point in time, and an ordered collection of changes to be applied to the base version of the file to bring it to further states it was in at some point in time, until the most recent update brings the file to its most updated version. Each base version and each change is identified by a unique identifier. When a receiver wishes to update a file, it sends to the sender a request containing the identifier of the last received version or change for the file. The sender then identifies according to the identifier, the version or change of the receiver, and sends back the collection of changes which when applied to the current version available to the receiver, will update the file to its latest content.

As more and more changes accumulate, the available disk space in the sender may decrease. Thus, when a decision mechanism, such as a “low water mark” or an efficiency determination mechanism detailed below indicates the need, a new version is created and the previous version and accumulated changes are evicted. The new base version is prepared by applying all accumulated changes to the previous base version. The previous base version as well as the previous changes are preferably stored in a location which does not have to be easily accessible as the version is not expected to be accessed. If a receiver sends a request containing an identifier which is not found by the sender, the sender presumes that the version available to the receiver is an outdated version, and sends the current base version and all changes accumulated since the current base version was the most updated one. Alternatively, the sender instructs the receiver on how to get the relevant changes from the storage containing the evicted versions.

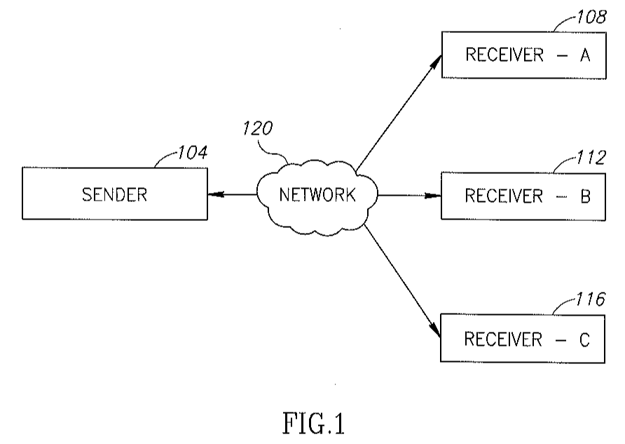

Referring now to FIG. 1, illustrating a typical environment in which the disclosed methods and apparatus are used. In a typical environment, one or more senders, such as sender 104 is connected through network 120 to one or more receivers such as receiver-a 108, receiver-b 112 or receiver-c 116. Any of sender 104, receiver-a 108, receiver-b 112 or receiver-c 116 is preferably a computing platform for performing the disclosed methods, which are preferably implemented as one or more software applications, libraries, executables or other components comprising one or more collections of computer instructions written in any programming language. Each computing platform can be for example a personal computer, a mainframe computer, a personal digital assistance (PDA), a cellular device, or any other type of computing platform that is provisioned with a storage device (not shown) a memory device (not shown), a CPU or microprocessor device, and several I/O ports (not shown). Alternatively, any of the senders or receivers may be implemented as firmware ported for a specific processor such as digital signal processor (DSP) or microcontrollers, or can be implemented as hardware or configurable hardware such as field programmable gate array (FPGA) or application specific integrated circuit (ASIC). Network 120 is any communication channel, such as any wired or wireless communication media, such as RF, a local area network (LAN), a wide area network (WAN), the Internet, Intra-net, telephone network, voice over IP and the like, employing commonly used protocols such as but not limited to TCP, IP, FTP, HTTP or derivatives thereof.

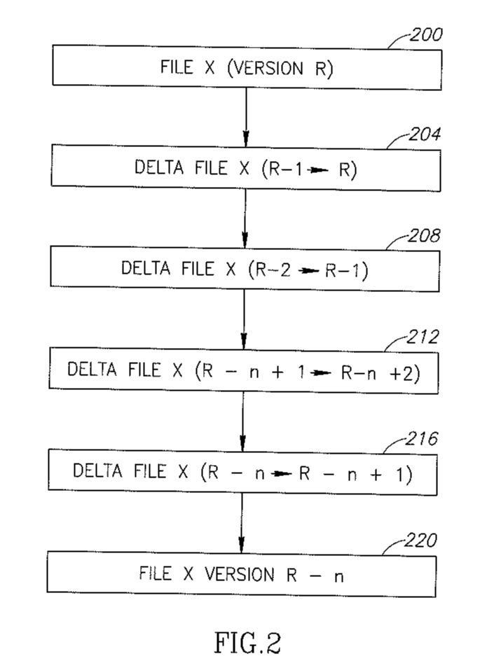

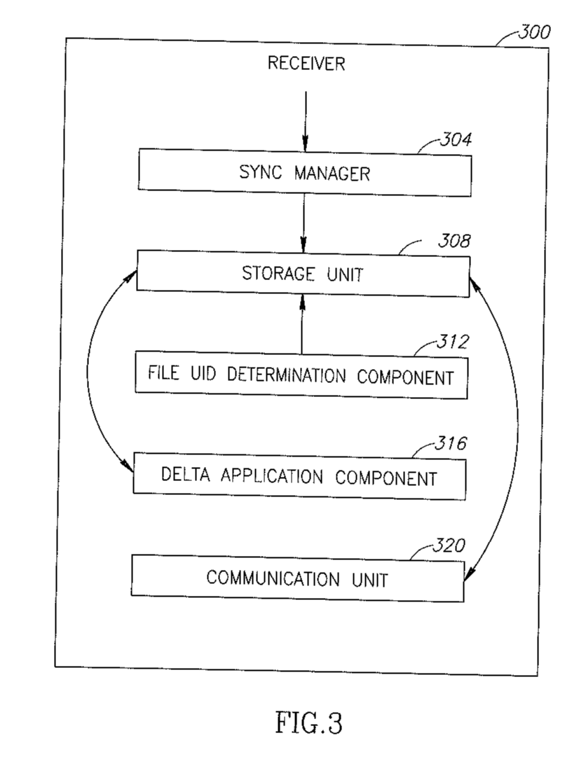

Referring now to FIG. 2, showing a schematic illustration of the data that is stored in association with a particular file at a sender and can be sent to a receiver in accordance with the disclosed subject matter. A particular file X 200 is stored on one or more senders and consumed by one or more receivers. The file is optionally updated, wherein a receiver receiving the file is supposed to get the latest update of the file. File X 200 can be a stand-alone file or part of a collection of files, such as products of “build” operation in a software development environment, a set of related documents, or the like. For file X (200), a sender such as sender 104 of FIG. 1 stores a complete version of the file, as it was at a certain point in time, the version denoted as file X version R-n (220), wherein R is the current version of file X, and file X has gone n changes since version R-n was stored. In addition, the sender stores all changes that were applied to the file since version R-n (220) and until the present. The changes are stored as files, wherein each file comprises the changes between two consecutive versions, i.e., it is a delta file (i→i+1) for some integer i. Thus, the changes for file X include delta file X(R-n→R-n+1) (216), delta file X(R-n+1→R-n+2) (212) . . . delta file X(R−2→R−1) (208), and delta file X(R−1→R) (204), wherein delta file X (a→b) denotes a file containing those changes that when applied to file X version a will yield file X version b. For example, suppose the currently available file version is 20, a sender can store the file as it was in version 16, and the changes that when applied will update the file to from version 16 to version 17, from version 17 to version 18, from version 18 to version 19, and from version 19 to version 20. Then, when a receiver requests a file, it indicates the version it has, and receives all necessary files to update to the most update version. If in the current example the receiver indicates that it has version 17, the sender will send delta files 17→18, 18→19, and 19→20. The receiver will then apply changes the three delta files to version 17, and thus yield version 20. However, if the receiver will indicate that it has a version prior to 16, for example version 13, the sender will send version 16, and delta files 16→17, 17→18, 18→19, and 19→20. The receiver will then store version 16, apply changes 16→17, 17→18, 18→19, and 19→20 and will thus yield version 20. In an alternative embodiment, the sender can instruct the receiver to get from a long-term storage or from another source all changes that when applied will transfer version 13 into version 16, and will then send stored delta files 16→17, 17→18, 18→19, and 19→20. In yet another alternative, the sender can store, subject to available disk space limitations, the most updated version as well. Then, if it is required to send to a receiver a full version (such as version 16) in addition to one or more delta files, it may be more efficient to just send the most updated version, e.g., full version 20. The sender can cache the full versions of one or more files which are required often so as to save computation time when the files are actually requested.

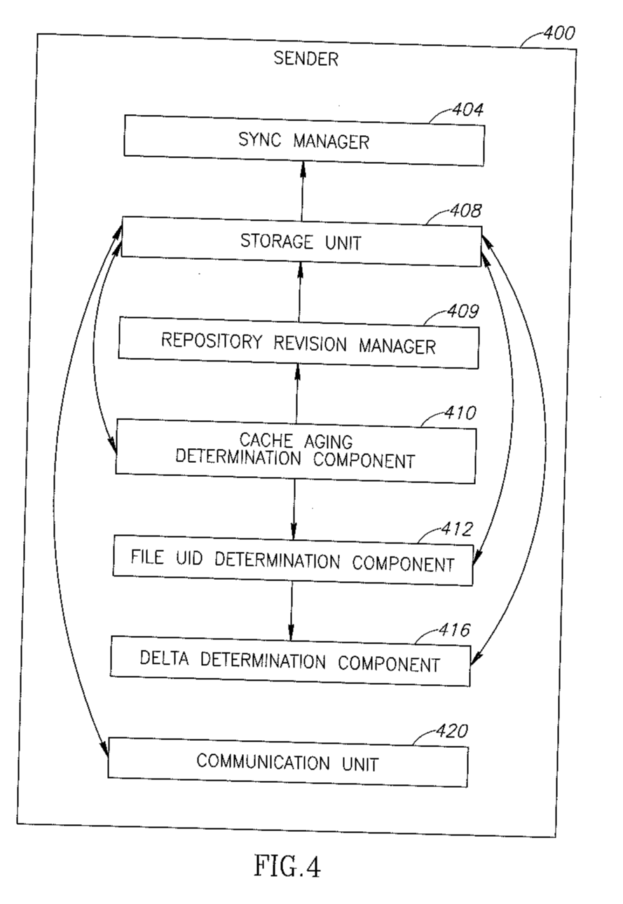

Referring now to FIG. 3, showing the components of the sender, which are used to synchronize one or more files between the sender and one or more receivers. Receiver 300, preferably being a computing platform, executes the software components detailed below. The software components, including sync manager 304, file UID determination component 312 (optional), delta application component 316 and the software parts of communication unit 320, are preferably implemented as one or more software components cooperating to perform the methods of the disclosure. Each component or collection of components can be an executable, a static library, a dynamic library, a module, a script file or any other executable component. The components can be written in any programming language, such as C, C++, C#, Java, VB, Perl, or others, and under any development environment, such as .Net, J2EE, or the like. The components of receiver 300 include a synchronization manager 304, for issuing an update request to a sender, and for reporting the version of the file available to the receiver and receiving the file information from the sender. The request can be issued every predetermined period of time, as a response to an update notification from a sender, or according to any other trigger. In yet another alternative, the synchronization manager can be omitted form the receiver, and the files can be sent at the sender's initiative, according to a predetermined rule. Receiver 300 comprises storage unit 308 for storing the updated files. Each updated file is either as received from the sender, or as yielded by applying changes received from the sender to an earlier file. Storage unit 308 can also store one or more delta files. Storage unit 308 can be external to receiver 300, which will require communication between receiver 300 to communicate with external storage, for example by any required protocol. Storage unit 308 is preferably a mass storage device, for example an optical storage device such as a CD, a DVD, or a laser disk; a magnetic storage device such as a tape or a hard disk; a semiconductor storage device such as Flash device, memory stick, or the like. Receiver 300 further comprises optional file UID determination component 312 for determining a unique ID associated with the available version of the file, and delta application component 316 for applying one or more delta files to a stored version according to the same syntax used by a sender to generate the delta files. The unique ID can be an arbitrary identifier attached to a file, a result of operations performed on the file such as MD5 hash algorithm, a checksum, or the like. File UID determination component 312 can be excluded from the receiver, and replaced by a storage mechanism used by a receiver to store a unique ID received for a file from the sender. Receiver 300 further comprises communication unit 320 for communicating with one or more senders, for selecting a sender, issuing requests from a sender and receiving responses and files from a sender. The communication can be in any required protocol, such as but not limited to HTTP, FTP, TCP, IP, or others.

Referring now to FIG. 4, showing a preferred embodiment of the components used by a sender in accordance with the disclosed subject matter. Sender 400, preferably being a computing platform, executes the software components detailed below. The software components, including sync manager 404, repository revision manager 49, cache aging determination component 416, file UID determination component 412, delta determination component 416 and the optional software parts of communication unit 420, are preferably implemented as one or more software components cooperating to perform the methods of the disclosure. Each component or collection of components can be an executable, a static library, a dynamic library, a module, a script file or any other executable component. The components can be written in any programming language, such as C, C++, C#, Java, VB, Perl, or others, and under any development environment, such as .Net, J2EE, or the like. The components of sender 400 include a synchronization manager 404, for optionally issuing an update notification to one or more senders due to a change in one or more files or another event such as a clock event. Synchronization manager 404 is also functional in responding to an update request to a sender, by sending the relevant file versions or delta files. Sender 400 comprises storage unit 408 for storing for each file an at least one full version, and optionally one or more delta files. Storage unit 408 can be external to sender 400, which will require communication between sender 400 to communicate with external storage, for example by any required protocol. Storage unit 408 is preferably a mass storage device, for example an optical storage device such as a CD, a DVD, or a laser disk; a magnetic storage device such as a tape or a hard disk; a semiconductor storage device such as Flash device, memory stick, or the like. Sender 400 further comprises repository revision manager 412 for managing the various version files and delta files available for each file. Repository revision manager 409 can optionally attach the unique ID determined by file UID determination component 412 detailed below to each version file and each delta file applied to a version file. A further component of sender 400 is cache aging determination component 410 functional in determining when an existing full version of a file, and a collection of one or more delta files should be evicted and replaced by a new version file. Later delta files will then relate to the newly stored version file. The previous version file and delta files can be moved to a less accessible location, and do not have to be managed by repository revision manager 409. The aging algorithm can take into consideration the number of changes, i.e. the number of delta files accumulated since the last eviction, the time period elapsed since the last eviction, the distribution of requests to a particular file, i.e. files for which updates are requested more often may be evicted more often, and similar considerations. Sender 400 further comprises file UID determination component 412 for determining a unique ID associated with the available version of the file. It will be appreciated by a person skilled in the art that all file UID determination components of one or more receivers associated a particular sender, and the file UID determination component of the respective sender, should employ algorithms that will yield the same result for the same file, so that synchronization between the sender and receivers is feasible. Similarly, if a particular receiver can receive files from multiple alternative senders, the receiver all senders must employ file UID determination components that will yield the identical result for files. A unique ID is determined for each version file, and for each file yielded by applying one or more delta files to a version file. For example, if version 16 is available, as well as delta files 16→17, 17→18 and 18→19, then unique ID will be determined for version 16, for version 16 after delta file 16→17 had been applied (can be referred to as “version 17”, although such file is not stored at the sender), for version 16 after having applied delta files 16→17 and 17→18 (“version 18”) and for version 16 after having applied delta files 16→17, 17→18 and 18→19 (“version 19”). Sender 400 further comprises delta determination component 416 for generating a delta file between two preferably consecutive versions of a file. Generating a delta file may change according to the file type, due to efficiency or storage considerations. For example, the UNIX “Diff” tool can be used for text files, while the UNIX “XDelta” tool can be used for binary files. Sender 400 further comprises communication unit 420 for communicating with one or more receivers, including issuing update notifications, receiving requests from a sender and issuing responses and files to a receiver. The communication can be in any required protocol, such as but not limited to HTTP, FTP, TCP, IP, or others.

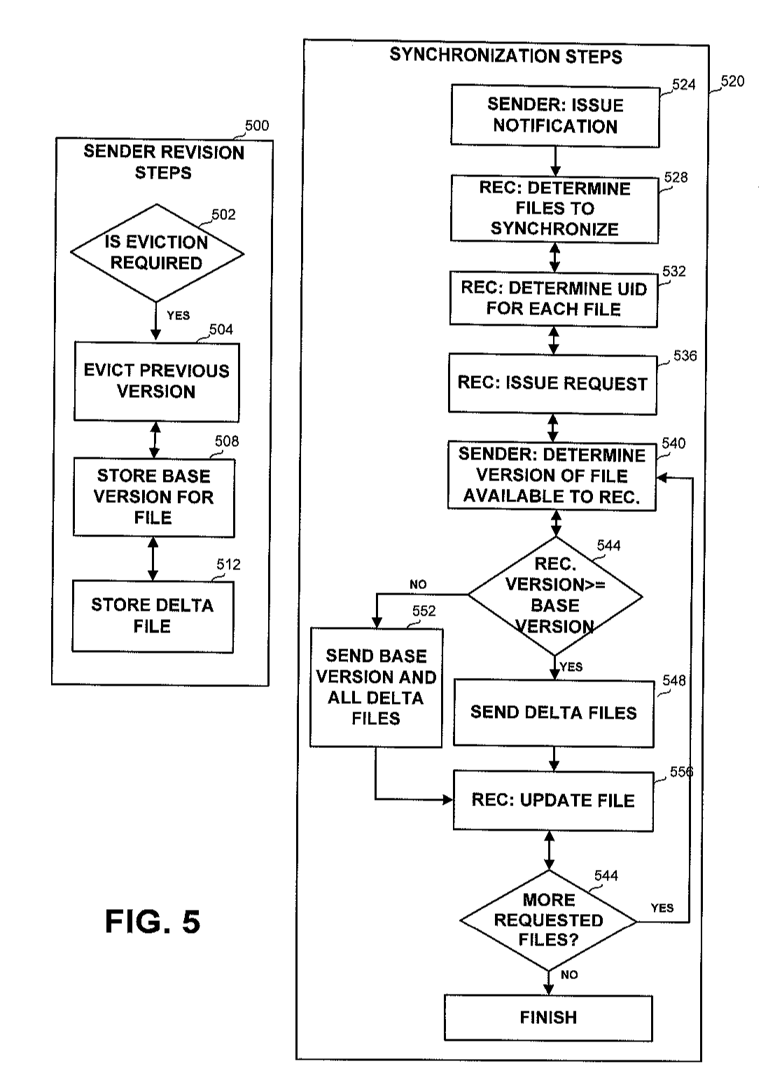

Referring now to FIG. 5, showing a flowchart of the main steps in distributing files from a sender to a receiver, in accordance with preferred embodiments of the disclosed subject matter. The flowchart shows sender revision steps 500 intended for arranging the files stored on a server, and synchronization steps 520. Steps 520 comprise step 502 for determining the need for eviction. Such need may be checked periodically. In a preferred embodiment on step 502 it is determined if one or more delta files were accumulated for the last base version stored for a particular file. If no changes were accumulated, then there is no need to evict the previous version. If the number of changes exceeds a predetermined number, the file can be evicted, and in other cases, the frequency in which the file is requested from a receiver can be checked. The higher the frequency the file is requested, the more often the file will be evicted. In another preferred embodiment, eviction takes place after a predetermined period of time has elapsed since the last eviction, the file is evicted even if only a single change was introduced. It will be apparent to a person skilled in the art that additional mechanisms can be proposed for determining if eviction is required, without deviating from the spirit of the disclosure. On optional step 504, the file is evicted, i.e. the current base file and all accumulated delta files are moved to another location, such as an external storage, or cheaper storage having longer access times. If no previous version exists, step 504 is not performed. On step 508, a new base file is stored, which comprises all changes accumulated until the present time. At later stages, when changes are made to the file, on step 512 each change is stored as a delta file, creating a collection comprising one or more delta files. It will be appreciated that after each time a base version is stored on step 503, one or more delta files can be stored on step 512. Optionally, for each stored base version and each stored delta file, a unique ID is determined and stored for the updated file, i.e. the current base version with all delta files applied at the base version.

Synchronization step 520 can be performed in an on-going manner, according to the change in files and the update requirements from receivers. On optional step 524, the sender issues a notification about one or more updated files, i.e. files for which a new delta file or a new base version was stored. The notifications can be issued every predetermined period of time, after at least a predetermined number of delta files were stored for a particular file, after a predetermined number of files were changed, or according to any other policy. Step 524 can also be skipped, leaving the receivers to request the file updates. On step 528 a receiver determines one or more files to be updated. A receiver can determine such file according to a notification received from a sender as described in association with step 524 above; according to a predetermined period of time that elapsed since the last update, according to a known association to another file that was changed, or any other policy. On step 532 the receiver determines a unique ID associated with the file to be updated. Step 532 can be performed once a file is stored, or the receiver can receive the unique ID from the server together with the files. On step 536 the receiver issues a request to the sender to receive an update of one or more files. The receiver can issue a separate request for each file, or collect a number of files into a single request. For each requested file, the associated unique ID is attached to the request. On step 540 the sender receives the request, and determines the version of the file related to the unique ID sent by the receiver. Step 540 can include determining the unique ID associated with the base version after applying incrementally the delta files. Alternatively, the unique ID determination is performed once when each base version or the delta file is stored as detailed in association with step 512 above. The sender then searches for the unique ID received from the receiver among the unique IDs of the base version and of the files created by applying incrementally the delta files to the base version. The sender thus determines the version of the file available to the receiver. Alternatively, the sender can keep track of which version was the last to be sent to each receiver. Then, on step 544 it is determined whether the version available to the receiver, as determined on step 536 is earlier or later than the base version available at the sender. If the version of the receiver is later than the base version of the sender, all delta files later than the last delta file sent to the receiver, or all delta files if the version available to the receiver is a base version, are sent on step 548. Otherwise, if the version available to the receiver is earlier than the base version, then the base version and all accumulated delta files, if exist, are sent to the receiver on step 552. Alternatively, instead of sending to the receiver a base version and one or more delta files, the latest full version as created ad-hoc or as previously cached by the sender is sent to the receiver.

In steps 548 and 552 the delta files are sent in a deterministic order, which complies with the order at which they were stored at the sender. On step 556 the receiver updates or initially stores the received files. If only delta files are received on step 548, the delta files are applied according to their order on the file as available to the receiver. If a new base version was sent to the receiver in step 552, the receiver stores the new base version, and if one or more delta files were sent, they are applied at the order in which they were sent to the base version. On step 544 it is determined by the server whether updates for more files are to be sent to the server. If there are additional files, steps 544, 548 or 552, and 556 are repeated for another file. When all files are handled, the process is finished.

The disclosed subject matter enables the synchronization of files between a sender and a receiver, in a storage-wise and performance-wise efficient manner. The sender stores only a limited number of changes to each particular file, and thus does not have to maintain a complex file hierarchy. The sender often sends only changes to a file rather than the whole file, which may provide significance savings in bandwidth requirements. The receiver does not have to store meta data related to each file for purposes of synchronization with the sender. Rather, the relevant IDs can be determined on demand when asking for an update. In preferred embodiments of the disclosure, the decision whether a file at the receiver should be updated can be left to the receiver. The sender may send a unique ID of the latest update of the file, and only if this ID is different then the ID available at the receiver, the receiver will request update to the file.

In a preferred embodiment, if a receiver requests a file for the first time, so that no prior version is available to the receiver, the receiver can send a predetermined ID, such as ‘0’, and the sender will send to the receiver the base version and all accumulated delta files.

It will be appreciated by a person skilled in the art that multiple changes and enhancements can be made to the disclosed methods and systems, without deviating from the spirit of the current disclosure. Such changes and enhancements are covered by the disclosed subject matter.

Structure and acts described herein are replaceable by equivalents, which perform the same function, even if the structure or acts are different, as known in the art. Therefore, only the elements and limitations as used in the claims limit the scope of the invention. When used in the following claims, the terms “comprise”, “include”, “have” and their conjugates mean “including but not limited to”.

1. In a computerized network comprising a sender computing platform and a receiver computing platform, a method for synchronizing an at least one file between the sender computing platform and the receiver computing platform, the method comprising:
storing an at least one base version for the at least one file at the sender;
storing a collection comprising an at least one delta file associated with the at least one file at the sender;
determining a version of the at least one file available at the receiver;
sending an at least one full version of the at least one file or an at least one delta file; and
updating the at least one base version at the receiver computing platform, or applying the at least one delta file to a previous version at the receiver computing platform.

2. The method of claim 1 further comprising the step of sending a request from the receiver computing platform to the sender computing platform, the request indicating the at least one file to be synchronized and an at least one identifier associated with the file.

3. The method of claim 1 further comprising the step of determining a unique ID for the base version of the at least one file.

4. The method of claim 3 further comprising the step of determining a unique ID for a version of the at least one file, the version of the at least one file comprising the base version of the at least one file, at which the at least one delta file is applied.

5. The method of claim 1 wherein the at least one delta file sent to the receiver comprises all delta files that have been stored at the sender computing platform after all earlier delta files were sent to the receiver computing platform.

6. The method of claim 1 wherein the full version is the base version.

7. The method of claim 1 wherein the full version is generated by applying the at least one delta files on the base version.

8. The method of claim 7 wherein the full version is cached by the sender.

9. The method of claim 1 further comprising the step of issuing an at least one notification from the sender computing platform to the receiver computing platform related to an at least one updated file.

10. The method of claim 1 further comprising the step of determining an at least one identifier associated with a version of the at least one file stored at the receiver computing platform.

11. The method of claim 1 further comprising the steps of:
evicting the at least one base version and the at least one delta file; and
storing an updated base version of the at least one file.

12. An apparatus for synchronizing an at least one file between a sender computing
platform and a receiver computing platform,
the sender computing platform comprising:
a storage unit for storing an at least one base version for the at least one file and an at least one delta file for the at least one file;
a synchronization manager for determining whether the at least one file needs to be updated;
a repository revision manager for managing the at least one base version and the at least one delta file;
a cache aging determination component for determining whether to evict the at least one base version and the at least one delta file;
a file unique ID determination component for determining a unique ID of the at least one base version or a unique ID of the base version at which the at least one delta file was applied;
a communication component for sending files to the receiver; the receiver computing platform comprising:
a storage unit for storing the at least one base version for the at least one file or an at least one delta file for the at least one file; or an at least one base version at which an at least one delta file was applied;
a delta application component for applying an at least one delta files to a stored version of the at least one file; and
a communication component for receiving files from the receiver.

13. The apparatus of claim 12 wherein the receiver further comprises a synchronization manager for issuing an update request to the sender related to the at least one file.

14. The apparatus of claim 12 wherein the receiver further comprises a file unique ID determination component for determining a unique ID of the at least one base version, or a unique ID of the at least one base version at which the at least one delta file is applied.

15. The apparatus of claim 12 wherein the sender further comprises a delta determination component for determining a delta file between two versions of a file.
